(19) United States
(12) Patent Application Publication
(10) Pub. No.: US 2020/0106496 A1
(43) Pub. Date: Apr. 2, 2020

(54) Rank Based Bluetooth Antenna Switch Diversity Algorithm

(71) Applicant: APPLE INC., Cupertino, CA (US)

(72) Inventors: Abhishek KAGITAPU, San Jose, CA (US); Qiyang Wu, San Francisco, CA (US); Xi Yang, Sunnyvale, CA (US); Vusthla Sunil Reddy, Cupertino, CA (US); Peter M. Agboh, Burlingame, CA (US)

(21) Appl. No.: 16/144,611

(22) Filed: Sep. 27, 2018

(51) Int. Cl. H04B 7/06; H04B 17/336; H04B 7/08; H01Q 1/22; H01Q 23/00; H04W 88/02

(52) U.S. Cl. CPC H04B 7/0602; H04B 17/336; H04B 7/0822; H01Q 1/243; H01Q 23/00; H04W 88/02; H01Q 1/2291

(57) ABSTRACT

A user equipment including an antenna arrangement comprising at least three antennas configured for use with a wireless connection is described. The user equipment performs a method including, for each antenna of the at least three antennas, determining a performance metric associated with a data exchange over the wireless connection, ranking each antenna of the at least three antennas based at least in part on the performance metric and selecting, when a data exchange error is detected, one of a first ranked antenna or a second ranked antenna of the at least three antennas for a next data exchange.

### BACKGROUND INFORMATION

A user equipment (UE) may be configured with a variety of different wireless communications capabilities. For example, the UE may be capable of establishing a wireless connection with a cellular network. The cellular network may be of any type of network such as a Long Term Evolution (LTE) network, a 3G network, a 4G network, a 5G network, etc. In another example, the UE may be capable of establishing a wireless connection with a WiFi network. The WiFi network may also be of any type, such as a home WiFi network, a public access point, a HotSpot, etc. In a further example, the UE may be capable of establishing a wireless connection with another UE (e.g., a peer connection). This connection may be made using a short-range or mid-range communication protocol, such as a Bluetooth or WiFi connection.

In view of these different types of connections, the UE may include a plurality of antennas with multiple radios to support wireless technologies (e.g., IEEE 802.11, Bluetooth, cellular, GPS, etc.) that may coexist. In one manner, the UE may utilize a single antenna to support a single wireless technology. However, the overall efficiency and performance may be improved through an antenna diversity scheme in which a plurality of antennas may be devoted to supporting a single wireless technology. For example, transmission may be performed using one of two available antennas.

### SUMMARY

In an exemplary embodiment, a method is performed by a user equipment including an antenna arrangement comprising at least three antennas configured for use with a wireless connection. The method includes, for each antenna of the at least three antennas, determining a performance metric associated with a data exchange over the wireless connection, ranking each antenna of the at least three antennas based at least in part on the performance metric and selecting, when a data exchange error is detected, one of a first ranked antenna or a second ranked antenna of the at least three antennas for a next data exchange.

In another exemplary embodiment, a user equipment having a transceiver, an antenna arrangement and a processor is described. The transceiver is configured to establish a wireless connection. The antenna arrangement includes at least three antennas configured for use with the wireless connection. The processor is configured to, for each antenna of the at least three antennas, determine a performance metric associated with a data exchange over the wireless connection, rank each antenna of the at least three antennas based at least in part on the performance metric and select, when a data exchange error is detected, one of a first ranked antenna or a second ranked antenna of the at least three antennas for a next data exchange.

In a still further exemplary embodiment, an integrated circuit for use in a device that is configured to establish a wireless connection using an antenna arrangement comprising at least three antennas configured for use with the wireless connection is described. The integrated circuit includes, for each antenna of the at least three antennas, circuitry to determine a performance metric associated with a data exchange over the wireless connection, circuitry to rank each antenna of the at least three antennas based at least in part on the performance metric and circuitry to select, when a data exchange error is detected, one of a first ranked antenna or a second ranked antenna of the at least three antennas for a next data exchange.

### BRIEF DESCRIPTION OF THE DRAWINGS

FIG. 1 shows an exemplary system in which a user equipment selects an antenna according to various exemplary embodiments described herein.

FIG. 2 shows an example of the user equipment in the system of FIG. 1 that utilizes antenna diversity according to various exemplary embodiments described herein.

FIG. 3 shows an exemplary state representation for selecting an antenna, according to various exemplary embodiments described herein.

FIG. 4 shows an exemplary method for selecting an antenna, according to various exemplary embodiments described herein.

### DETAILED DESCRIPTION

The exemplary embodiments may be further understood with reference to the following description and the related appended drawings, wherein like elements are provided with the same reference numerals. The exemplary embodiments are related to devices, systems, and methods for selecting an antenna of a user equipment (UE) for use in a data exchange over a wireless connection. For example, the wireless connection may be established with a short-range communication protocol, such as a Bluetooth connection. The UE may utilize an antenna diversity arrangement in which more than one Bluetooth antenna is available to be used for the exchange of data over the wireless connection. The exemplary embodiments provide a mechanism by which the selection of the Bluetooth antenna used for transmission utilizes a polling procedure to generate a performance metric for two or more available Bluetooth antennas and determine subsequent operations based on the polling procedure and performance metric.

Initially, the exemplary embodiments are described herein with regard to antenna selection for a Bluetooth connection. However, the use of a Bluetooth connection and performing the antenna selection for this wireless connection is only exemplary. The exemplary embodiments may be modified for use with any type of wireless connection. The exemplary embodiments are also described herein with regard to a UE. However, the UE is only exemplary. The exemplary embodiments may be utilized with any device that may establish one or more connections as well as one or more types of connections (e.g., to a network, to a device, etc.) as well as be configured with the hardware, software, and/or firmware to establish one or more connections such as an antenna arrangement including a plurality of antennas in which one or more of these antennas may be used for a particular type of connection. Therefore, the UE as described herein is used to represent any device capable of establishing these connections.

The exemplary embodiments are described herein with regard to an antenna diversity arrangement (or mechanism) in which the Bluetooth connection may be established using any of three different antennas. However, the antenna diversity arrangement described with respect to three different antennas is only exemplary. The exemplary embodiments may be configured or modified to be used where the antenna diversity arrangement includes at least two antennas that can be used in conjunction with the Bluetooth connection. As those skilled in the art will appreciate in light of the exemplary embodiments, the mechanism in which to select the antenna may be extended to any number of antennas.

The exemplary embodiments relate to configurations where the UE may include more than two antennas that may be used to establish a Bluetooth connection. When the UE is only equipped with a single Bluetooth antenna (e.g., due to form factor reasons), any time that the Bluetooth connection is required, the UE selects the one available Bluetooth antenna and performs the wireless communication. Those skilled in the art will understand that other operations may be performed such as monitoring for a preferred Bluetooth channel over which the wireless communication is to be performed. However, with regard to antenna selection, the UE is not presented with an option and is only capable of utilizing the single Bluetooth antenna that is provided.

Although using a single Bluetooth antenna may simplify the selection process, there may be scenarios in which having more than one Bluetooth antenna that is available for use with the Bluetooth connection provides improved performance. For example, a first one of the Bluetooth antennas may experience an interference issue that a second one of the Bluetooth antennas may not experience. Thus, one manner of improving an overall performance of the Bluetooth connection is by equipping the UE with a diversity antenna where two or more antennas may be available for use with the Bluetooth connection. When the UE is equipped with two or more Bluetooth antennas, the UE selects which Bluetooth antenna to use, e.g., to perform a data exchange. As those skilled in the art will understand, the plurality of Bluetooth antennas may refer to individual physical antennas.

With the introduction of antenna diversity in which two different Bluetooth antennas may be utilized by the UE, various selection schemes may be used. For example, based on a relative location on the UE, the first Bluetooth antenna may be an upper Bluetooth antenna while the second Bluetooth antenna may be a lower Bluetooth antenna. A typical selection scheme used by UEs is a blind switch scheme in which one of the upper or lower Bluetooth antenna is selected when the other one of the upper or lower Bluetooth antenna experiences an error, such as missing a packet or receiving a NACK for a transmitted packet from a recipient UE. The selected Bluetooth antenna may continue to be used until a subsequent error occurs and another blind switch is performed.

Although antenna diversity and the blind switch scheme provide a strategy for the Bluetooth connection, the blind nature of the antenna selection may be inefficient and may not significantly improve the overall quality of the Bluetooth connection. In addition, the introduction of a third (or greater) Bluetooth antenna may further complicate the selection process. For example, the blind switch scheme may be a relatively simple scheme, since no further operations or considerations are used. The benefit of the blind switch scheme is based on a simple switch being performed when the other Bluetooth antenna has failed.

Where the UE has more than two Bluetooth antennas, the exemplary embodiments provide a mechanism by which the UE performs a polling operation. Through polling, one of the Bluetooth antennas is selected (via the selection process) to perform one or more data exchanges and results of using the selected antenna may be used to determine one or more subsequent operations and/or selections. As will be described in further detail below, the polling operation may cycle through each Bluetooth antenna to perform a predetermined number of data exchanges (e.g., transmit and/or receive). While performing these data exchanges, when a selected Bluetooth antenna experiences an error, a ranking operation based on a performance metric may identify two of the more than two Bluetooth antennas that have performed better in recent history for the blind switch scheme to be utilized. The UE may include further operations to revert to the polling operation or utilize a fallback operation to select one of the remaining Bluetooth antennas.

For illustrative purposes, the exemplary embodiments are described from the perspective of performing the polling operation with respect to receiving data by a UE that is determining how the Bluetooth antennas are to be selected and used. Accordingly, the selection of a Bluetooth antenna for use in transmitting data (e.g., a message) may be based on the information and results gathered from use of the Bluetooth antenna to receive data. However, using the receive operation of a data exchange to form the basis for selecting a Bluetooth antenna is only exemplary. Those skilled in the art will understand that information and results from transmitting data using one or more Bluetooth antennas may also be used to select a Bluetooth antenna, either exclusively or in combination with the information and results from receiving data.

For illustrative purposes, the exemplary embodiments are described with regard to the performance metric being based on a signal to noise ratio (SNR). However, the use of the SNR is only exemplary. In some embodiments, the performance metric can be based on one or more additional or different measurements or can incorporate one or more other network measurements that may be performed during the course of using the Bluetooth connection (e.g., power headroom, block error rate (BLER), etc.).

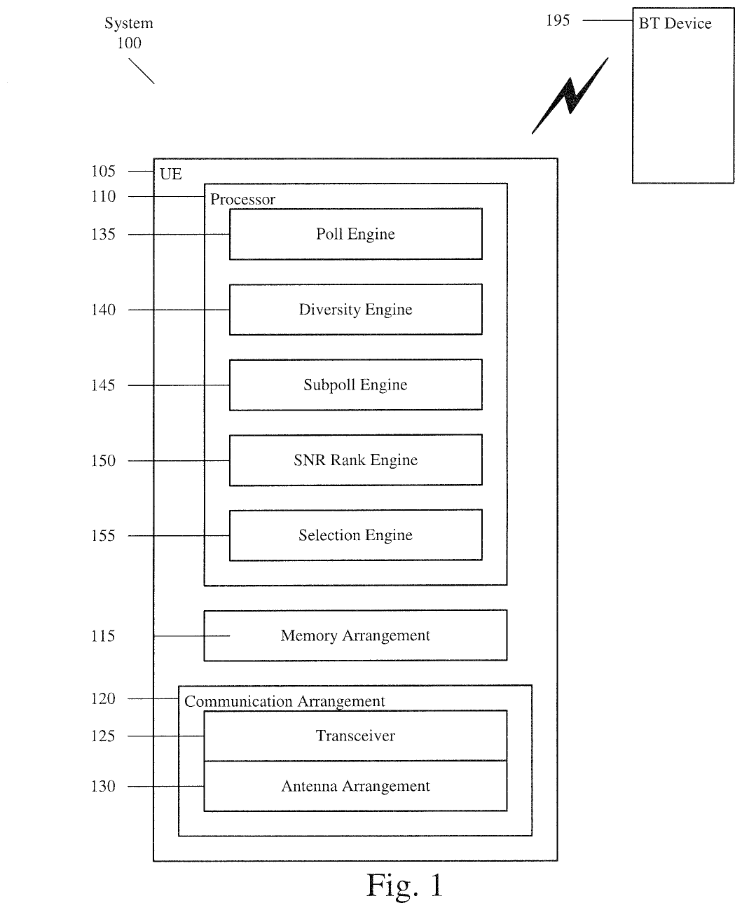

FIG. 1 shows an exemplary system 100 in which a UE 105 selects a Bluetooth antenna according to various exemplary embodiments described herein. The system 100 includes the UE 105 that communicates over a Bluetooth connection with a Bluetooth device 195. For example, the UE 105 may be a portable device (e.g., a cellular phone, a smartphone, a tablet computer, a phablet, a laptop, an embedded device, a wearable device, a Cat-M device, a Cat-M1 device, a MTC device, an eMTC device, another type of an Internet of Things (IoT) device, etc.) or a stationary device (e.g., a desktop terminal, a server, etc.). The Bluetooth device 195 may be another portable or stationary device (e.g., another smartphone, an earpiece, ear buds, a headset, a speaker, a display device, a smart watch, etc.).

The UE 105 may operate on a variety of different frequencies or channels (e.g., ranges of contiguous frequencies) associated with a Bluetooth connection. However, the UE 105 may also operate over channels corresponding to one or more of a cellular connection, a WiFi connection, an ultrawide-band connection, an NFC connection, etc. Accordingly, the UE 105 may include components that enable different radio access technologies and communication protocols. As shown in FIG. 1, the UE 105 may include a processor 110, a memory arrangement 115, and a communication arrangement 120 including a transceiver 125 and an antenna arrangement 130 of Bluetooth antennas. In some embodiments, the communication arrangement can include multiple transceivers and multiple antenna arrangements. The UE 105 may also include further components such as any/all of a display device, an input/output (I/O) device, and other components such as a portable power supply, an audio I/O device, etc.

The processor 110 may be configured to execute a plurality of engines of the UE 105. For example, the engines may include a poll engine 135, a diversity engine 140, a subpoll engine 145, a SNR rank engine 150, and a selection engine 155. The poll engine 135 may be configured to select, for a given opportunity (e.g., transmit or receive) the Bluetooth antenna to use. The poll engine 135 may track data (or message) reception attempts and the corresponding outcome of each tracked data reception attempt. The poll engine 135 may also track data (or message) transmission attempts and the corresponding outcome of each tracked data transmission attempt. The poll engine 135 may perform predetermined subsequent actions based on the outcome of one or more tracked data reception attempts. The diversity engine 140 may be configured to select which Bluetooth antenna to use in receiving a packet, including a retransmitted packet. For example, the diversity engine 140 may be called upon when a transmitted packet resulted in an error. The subpoll engine 145 may be configured to select the Bluetooth antenna to be used in receiving a packet when a predetermined number of errors results in using the diversity engine 140. The SNR rank engine 150 may be configured to determine SNR information and determine a rank of the Bluetooth antennas. The selection engine 155 may be configured to receive selection information from each of the engines to implement a selection of one of the available Bluetooth antennas.

Representation of the above noted engines as applications (e.g., a program) executed by the processor 110 is only exemplary. The functionality associated with the engines may also be implemented as a separate, incorporated component of the UE 105 or may be implemented as a modular component coupled to the UE 105, e.g., an integrated circuit with or without firmware. For example, the integrated circuit may include input circuitry to receive signals and processing circuitry to process the signals and other information. The engines may also be embodied as one combined application, as separate applications, or as part of one or more multifunction programs. Accordingly, the applications may be implemented in a variety of manners in hardware, software, firmware, or a combination thereof. In addition, in some UEs, the functionality described for the processor 110 can be split among two or more processors such as a baseband processor and an applications processor, as will be described in further detail below. The exemplary embodiments may be implemented in any of these or other configurations of a UE.

The memory arrangement 115 may be a hardware component configured to store data related to operations performed by the UE 105. For example, the memory arrangement 115 may store measurements and/or tracking information of operations associated with using the Bluetooth connection to perform data reception attempts. The information used by the SNR rank engine 150 may be stored in the memory arrangement 115.

The communication arrangement 120 may support the different wireless technologies that may be used by the UE 105. For example, the communication arrangement 120 may enable the UE 105 to establish and use the Bluetooth connection via the transceiver 125 and the antenna arrangement 130. The transceiver 125 may be a component of the UE 105 that enables communication with other devices over one or more communication pathways. For example, the transceiver 125 may enable wireless Bluetooth communications to be performed. When the UE 105 is capable of a plurality of different types of wireless connections, the transceiver 125 may be equipped with one or more radios that are capable of performing wireless communications over a plurality of different wireless connections, including any/all of a Bluetooth connection, a cellular connection, a WiFi connection, an NFC connection, etc. Accordingly, the transceiver 125 may include one or more Bluetooth modules, such as integrated circuits.

The antenna arrangement 130 may be any configuration of one or more antennas that enable the transceiver 125 to perform the wireless communications over the different wireless connections. For example, the antenna arrangement 130 may utilize an antenna diversity arrangement in which two or more antennas in the antenna arrangement 130 may be used by the Bluetooth connection. For example, the antenna arrangement 130 can include one or more dedicated Bluetooth antennas and/or one or more shared antennas that can be used for Bluetooth communications and communications corresponding to at least one other protocol.

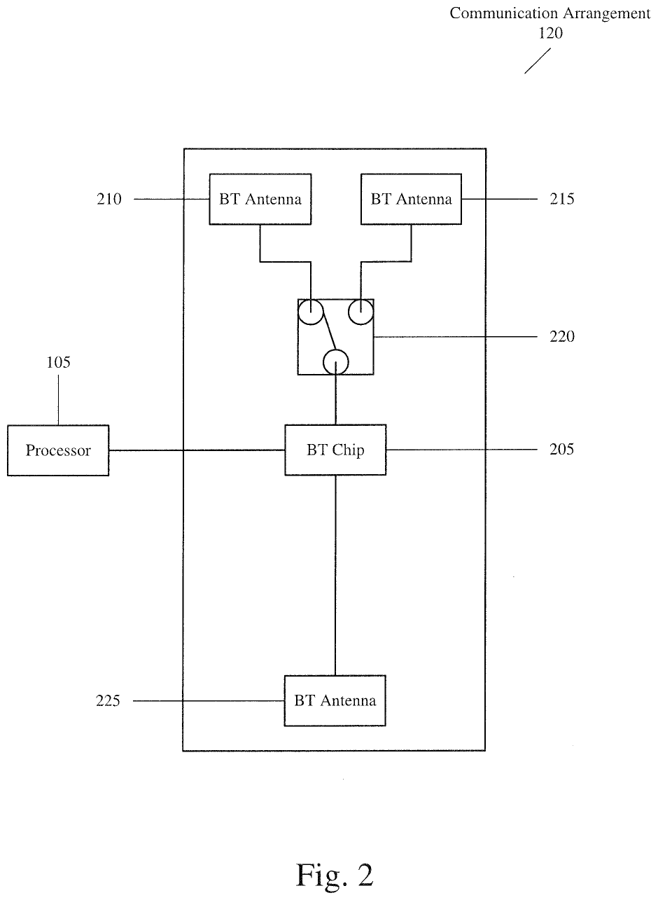

FIG. 2 shows the UE 105 in the system 100 of FIG. 1 that utilizes antenna diversity in the antenna arrangement 130 according to various exemplary embodiments described herein. For example, FIG. 2 shows an exemplary set of connections within the communication arrangement 120 and with the processor 105. As illustrated, the processor 105 may be connected to a Bluetooth chip (or integrated circuit (“IC”)) 205 that is part of the transceiver 125. Thus, the processor 105 (e.g., via the engines 135-155) may instruct the Bluetooth chip 205 to utilize a particular one of the available Bluetooth antennas. In some embodiments, the antenna arrangement 130 may include three Bluetooth antennas 210, 215, 225. The Bluetooth antennas 210, 215 may represent first and second upper Bluetooth antennas, while the Bluetooth antenna 225 may represent a lower Bluetooth antenna. Each of the Bluetooth antennas 210, 215, and 225 can be a dedicated Bluetooth antenna or a shared Bluetooth antenna. The exemplary antenna arrangement 130 is described as including three physical Bluetooth antennas, however other arrangements of at least two antennas available for Bluetooth communications are possible.

When the processor 105 instructs the Bluetooth chip 205 to select a particular one of the Bluetooth antennas 210, 215, 225, the Bluetooth chip 205 may utilize a set of connections to each of the Bluetooth antennas 210, 215, 225. For example, since the Bluetooth antenna 225 is the only lower Bluetooth antenna, there may be a direct connection between the Bluetooth chip 205 and the Bluetooth antenna 225. In another example, since the Bluetooth antennas 210, 215 are both upper Bluetooth antennas, there may be a switch 220 used to select between the two upper Bluetooth antennas 210, 215. As illustrated, the switch 220 may be oriented to select the Bluetooth antenna 210.

The Bluetooth antennas 210, 215 being referred to as upper and the Bluetooth antenna 225 being referred to as lower is only exemplary. That is, the relative position of the Bluetooth antennas 210, 215, 225 in the UE 105 is only exemplary. The Bluetooth antennas 210, 215, 225 may be positioned at any relative location in or on the UE 105. For example, in another exemplary embodiment, the antenna arrangement 130 may include a Bluetooth antenna disposed on a left edge while another Bluetooth antenna may be disposed on a right edge. Therefore, the upper and lower positions described herein are only exemplary and any relative orientation and configuration may be used. In another example, the antenna arrangement 130 may be arranged with any number of interior and/or exterior antennas.

The use of three Bluetooth antennas in the antenna arrangement 130 is only exemplary. The exemplary embodiments may be utilized with any number of Bluetooth antennas, e.g., three or more. Those skilled in the art will understand that in view of the description herein, the exemplary embodiments may be modified or extended to four or more Bluetooth antennas. Further, the exemplary embodiments may be modified for use with two antennas.

When the UE 105 is configured to utilize further wireless technologies, the transceiver 125 may include one or more additional wireless technology chips (or processors, modules, ICs, etc.) in addition to the Bluetooth chip 205. In addition, the antenna arrangement 130 may include one or more further antennas to support these one or more additional wireless technology chips. However, the Bluetooth antennas 210, 215, 225 may also be configured to be used with the one or more additional wireless technologies. Thus, as those skilled in the art will understand, the physical antennas may not define the total number of antennas available to establish the different wireless connections as one physical antenna may be used for two or more wireless connections (e.g., the Bluetooth antenna 210 may also be used for a particular cellular connection or a WiFi connection).

According to the exemplary embodiments, the UE 105 may be configured to select among the Bluetooth antennas 210, 215, 225 to receive data from the Bluetooth device 195. The Bluetooth antennas 210, 215, 225 may be used for reception as well as transmission of data over the Bluetooth connection. As will be described in further detail below, the Bluetooth antennas 210, 215, 225 may be periodically polled to collect the corresponding SNR values while performing a data exchange. The SNR values may be used to rank the Bluetooth antennas 210, 215, 225 where the highest SNR antenna may have a highest rank. In the event of a retransmission (e.g., an initial reception attempt resulted in an error), the two highest SNR antennas may be identified so that a selection between these two antennas is performed for the retransmission. In this manner, the exemplary embodiments utilize the SNR values and the conditions of the Bluetooth connection to select the Bluetooth antenna to perform the data exchange. The SNR values and the rank of the Bluetooth antennas 210, 215, 225 may be updated periodically and/or when an error occurs. The mechanism according to the exemplary embodiments may take effect when the handshaking messages are exchanged between the UE 105 and the Bluetooth device 195. However, the mechanism according to the exemplary embodiments may take effect at any time, prior or subsequent to the handshaking messages.

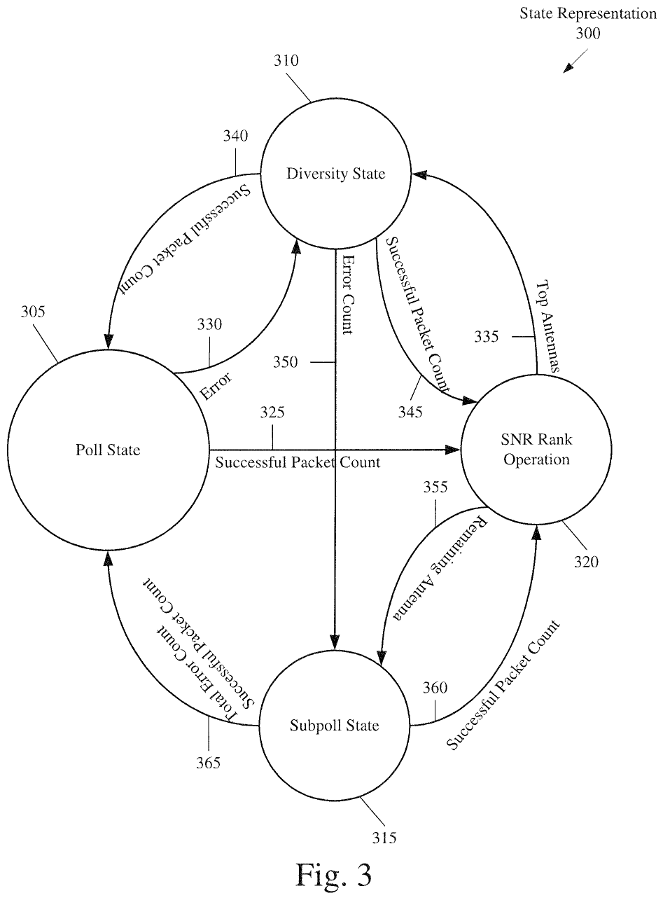

The exemplary embodiments may include a polling procedure that may be performed by the poll engine 135 and the subpoll engine 145. The exemplary embodiments may also utilize a blind switch scheme performed by the diversity engine 140 based on ranks determined by the SNR rank engine 150 using SNR values corresponding to data exchanges performed using the Bluetooth antennas 210, 215, 225. Based on the outputs of the engines 135-150, the selection engine 155 may generate an output that instructs the Bluetooth chip 205 to use a selected one of the Bluetooth antennas 210, 215, 225 to perform a data exchange. The functionality of each of the engines 135-155 will be described in an individual capacity along with the interaction of the engines 135-155 in performing data exchanges. FIG. 3 shows an exemplary state representation 300 for selecting an antenna according to various exemplary embodiments described herein. The state representation 300 of FIG. 3 illustrates the interaction of selection states. The selection states may include a poll state 305, a diversity state 310, and a subpoll state 315 corresponding to the functionalities of the poll engine 135, the diversity engine 140, and the subpoll engine 145, respectively. The state representation 300 may also include a SNR rank operation 320 corresponding to the functionality of the SNR rank engine 150.

The mechanism according to the exemplary embodiments may begin with the poll engine 135, illustrated by the poll state 305 in FIG. 3. As described above, the poll engine 135 may procedurally select the Bluetooth antennas to receive data. The poll engine 135 may periodically poll the Bluetooth antennas 210, 215, 225. According to the exemplary embodiments, polling may refer to selecting a first one of the Bluetooth antennas 210, 215, 225 (e.g., Bluetooth antenna 210) to be the active antenna to be used in receiving data from the Bluetooth device 195. The first Bluetooth antenna may remain as the active antenna until a predetermined threshold number of consecutive packets (e.g., three packets) is successfully received. Once the first Bluetooth antenna has successfully received the predetermined threshold number of consecutive packets, the poll engine 135 switches and selects a second one of the Bluetooth antennas 210, 215, 225 (e.g., Bluetooth antenna 215). The second Bluetooth antenna is used in a substantially similar manner as the first Bluetooth antenna. For example, the second Bluetooth antenna is set to the active antenna (while the first Bluetooth antenna is deactivated) and the second Bluetooth antenna is used to receive data from the Bluetooth device 195 until the predetermined threshold number of consecutive packets is successfully received. Using this polling procedure, the poll engine 135 may switch and select a third one of the Bluetooth antennas 210, 215, 225 (e.g., Bluetooth antenna 225). In this manner, the poll engine 135 may cycle through each of the Bluetooth antennas 210, 215, 225. While this cycling is performed, the procedure may remain in the poll state 305.

The poll engine 135 may select any order to cycle through the Bluetooth antennas 210, 215, 225. The cycling order may be a predetermined order (e.g., as set by an administrator) or a dynamically selected order (e.g., based on historical performance information to select the historically best performing Bluetooth antenna first and the worst performing Bluetooth antenna last). The cycling order may also be maintained throughout the duration that the poll engine 135 is performing its functionality or may be modified dynamically, after each cycle, or after a predetermined number of cycles, so long as each of the Bluetooth antennas 210, 215, 225 is selected prior to changing the order.

The poll engine 135 may also track data reception attempts and the corresponding outcome of each tracked data reception attempt. The above described polling procedure in which a selected one of the Bluetooth antennas 210, 215, 225 is set as the active antenna may be used until a change condition arises, e.g., an error has occurred with receiving a packet from the Bluetooth device 195. The error may be an implicit error or an explicit error. The implicit error may be when a packet is intended to be received but the UE 105 misses the reception for any of a variety of reasons (e.g., failure by the Bluetooth device 195, an unregistered change to the scheduling, etc.). In some implementations, an implicit error can be determined based on failure to receive a packet in a scheduled time slot. The explicit error may be when the packet is intended to be received, is at least partially received, but is received improperly (e.g., a cyclic redundancy check (CRC) indicates that the packet was not properly received). In an exemplary error sequence, in a given cycling order, the first Bluetooth antenna may be polled and used for the predetermined threshold number of consecutive packets. The polling procedure continues to a second Bluetooth antenna. The second Bluetooth antenna may be polled and experience an error prior to the predetermined threshold number of consecutive packets. For example, with the predetermined threshold number of consecutive packets being three, the second Bluetooth antenna may have experienced an error on the second packet, meaning the first packet was successfully received. Once this error is registered, the subsequent operations that may be performed may depend on the SNR values tracked by the SNR rank engine 150. In one example, as will be described in detail below, if sufficient SNR information is available for the diversity engine 140 to be used, the polling procedure of the poll engine 135 may be terminated and the diversity engine 140 may perform its functionality. However, if sufficient SNR information is unavailable for the diversity engine 140 to be used, the polling procedure of the poll engine 135 may continue by switching to the next Bluetooth antenna (in this instance, the third Bluetooth antenna). As will be described below and as illustrated in FIG. 3, an error 330 while polling in the poll state 305 may result in transitioning to the diversity state 310.

During the polling procedure and while the mechanism according to the exemplary embodiments is being used (e.g., in the poll state 305), the SNR rank engine 150 may measure a SNR for each reception attempt. For example, whenever the predetermined threshold number of consecutive packets in the polling procedure, or at least one packet in the polling procedure prior to an error occurring is successfully received using one of the Bluetooth antennas 210, 215, 225, a successful packet count 325 may be indicated to the SNR rank operation 320. As described above, the SNR rank engine 150 may determine SNR information and determine a rank of the Bluetooth antennas 210, 215, 225. Those skilled in the art will understand the various ways in which the SNR may be measured for an antenna during a time a data exchange is occurring. For example, a signal power and a noise power may be measured. A ratio of these powers may then indicate the SNR. The SNR rank engine 150 may measure individual SNR values for a given Bluetooth antenna that is being polled. The SNR rank engine 150 may subsequently determine an average SNR value for the polled Bluetooth antenna for the current cycle of the polling procedure. The SNR rank engine 150 may be configured to determine the average SNR value when a predetermined packet threshold for averaging packets has been reached and thereafter. For example, when the predetermined packet threshold is set to three, the SNR rank engine 150 may average the measured SNR values at each time that the three packets were received. If a fourth packet is received, the SNR rank engine 150 may again determine the average SNR value based on the measured SNR values for this iteration that the Bluetooth antenna is being used to receive packet, e.g., averaging values for packets 2, 3, and 4.

Using the same value for the predetermined threshold of consecutive packets used for polling and the predetermined packet threshold used for averaging is only exemplary. The predetermined threshold of consecutive packets and the predetermined packet threshold for averaging may be the same value or different values. However, in view of the manner in which the mechanisms according to the exemplary embodiments operate, the predetermined threshold of consecutive packets may be greater than or equal to the predetermined packet threshold (e.g., if the predetermined threshold of consecutive packets were less than the predetermined packet threshold, an average SNR value would be incapable of being determined as the Bluetooth antenna would be switched before the predetermined packet threshold is reached). Averaging the SNR values is only exemplary as other statistical manners of evaluating the SNR values may also be used.

As the SNR rank engine 150 gathers SNR values (e.g., in the poll state 305), SNR information for the Bluetooth antennas 210, 215, 225 may generated. Once SNR information for at least one of the Bluetooth antennas 210, 215, 225 is generated, the SNR rank engine 150 may rank the Bluetooth antennas 210, 215, 225 based on the SNR information and performance metric. In this manner, the two top performing Bluetooth antennas may be identified for subsequent operations. Similarly, the remaining Bluetooth antenna (e.g., in the case of three) may also be identified. As illustrated, a top antennas indication 335 may be used in the diversity state 310 and a remaining antenna indication 355 may be used in the subpoll state 315.

The SNR rank engine 150 may also determine whether the SNR information includes an average SNR value that is at least a predetermined minimum SNR value. The predetermined minimum SNR value may be dynamically selected based on current conditions or may be determined/updated while the UE 105 utilizes the mechanism according to the exemplary embodiments. The polling procedure performed by the poll engine 135 may terminate when SNR information is available or may continue when SNR information is unavailable. This determination of SNR information being available may be whether the SNR information indicates at least one of the Bluetooth antennas 210, 215, 225 has an average SNR value that meets the predetermined minimum SNR value. Thus, if the SNR information positively indicates that at least one of the Bluetooth antennas 210, 215, 225 meets the minimum SNR value, the polling procedure may terminate and the diversity engine 140 may perform its functionality. The error 330 may lead to the transition from the poll state 305 to the diversity state 310. If the SNR information does not indicate that any of the Bluetooth antennas 210, 215, 225 meets the minimum SNR value, the polling procedure may continue by switching to another Bluetooth antenna. Despite the error, the procedure may remain in the poll state 305. Accordingly, when an error is experienced during the polling procedure performed by the poll engine 135, the SNR rank engine 150 may provide an indication of the SNR information so that the poll engine 135 may determine whether to continue or terminate the polling procedure.

When the UE 105 experiences an error while receiving a packet, the poll engine 135 may terminate the polling procedure when SNR information is available to activate use of the diversity engine 140 (e.g., at least one of the Bluetooth antennas 210, 215, 225 has an average SNR value that is at least the predetermined minimum SNR value). Again, the procedure may transition from the poll state 305 to the diversity state 310. The at least one Bluetooth antenna of the Bluetooth antennas 210, 215, 225 that satisfies this predetermined minimum SNR value criteria may be the same Bluetooth antenna that experienced the error. As will become evident below, the error may be an instantaneous occurrence in time whereas the average SNR value satisfying the predetermined minimum SNR value criteria may represent a likelihood that the Bluetooth antenna may be used to successfully receive a packet.

As described above, the diversity engine 140 may select the Bluetooth antenna to be used in receiving a retransmitted packet. The diversity engine 140 may be called upon when a transmitted packet resulted in an error. As described above, the error 330 may have transitioned the procedure to the diversity state 310. When the diversity engine 140 is to be used, the diversity engine 140 may receive information from the SNR rank engine 150 regarding a rank for the Bluetooth antennas 210, 215, 225. The SNR rank engine 150 may utilize the SNR information to determine a performance based ordering of the Bluetooth engines 210, 215, 225. The SNR rank engine 150 may also indicate the two (or multiple) highest ranked of the Bluetooth antennas 210, 215, 225 that are to be used by the diversity engine 140 (e.g., in the top antennas indication 335). In this manner, the diversity engine 140 may consider these indicated Bluetooth antennas based on the measured SNR values because the SNR rank engine 150 is recording SNR values for the Bluetooth antennas for time slots that the poll engine 135 is performing its functionality. The top antennas indication 335 may be provided periodically, e.g., when the ranking of the Bluetooth antennas 210, 215 225 changes or at various intervals.

When called upon, the diversity engine 140 may subsequently select the active antenna to receive a retransmitted packet. For example, the diversity engine 140 may select the top ranked of the two or more indicated Bluetooth antennas. However, if the error was experienced by the top ranked of the indicated Bluetooth antennas, the diversity engine 140 may select the other (or another) of the indicated Bluetooth antennas. For example, if two Bluetooth antennas are indicated, the other antenna is selected. Thus, the same Bluetooth antenna may be prevented from being selected by the poll engine 135 and then immediately by the diversity engine 140. The diversity engine 140 may select one of these two Bluetooth antennas to be the active antenna to be used in the retransmission data exchange.

In a substantially similar manner as the polling procedure performed by the poll engine 135, with regard to the diversity engine 140, the selected Bluetooth antenna may be used until a predetermined threshold of consecutive packets have been successfully received. The predetermined threshold of consecutive packets used by the diversity engine 140 may be the same as the predetermined threshold of consecutive packets used by the poll engine 135 or it may be set to a different value. Once the selected Bluetooth antenna has been used to successfully receive the predetermined threshold of consecutive packets, the diversity state 310 may be considered successful and the diversity engine 140 may terminate its functionality and the poll engine 135 may continue or restart the polling procedure (e.g., select the next Bluetooth antenna in the cycle or start a new cycle). As illustrated, the predetermined threshold of consecutive packets may result in a successful packet count 340 such that the procedure transitions from the diversity state 310 back to the poll state 305. The case of an error being encountered in the diversity state 310 will be described below.

The SNR rank engine 150 may again be used while the diversity engine 140 is being used. For example, when the predetermined packet threshold has been reached and for each subsequent packet (if applicable) or for successfully received packets prior to encountering an error, the SNR rank engine 150 may update the average SNR value associated with the selected Bluetooth antenna. As illustrated, in a manner substantially similar to the successful packet count 325, a successful packet count 345 may be provided to the SNR rank operation 320. However, in contrast to when the predetermined packet threshold was used during the polling procedure performed by the poll engine 135 where the average SNR value and the rank is updated, the SNR rank engine 150 may only update the average SNR value when the diversity engine 140 is being used. For example, the rank of the Bluetooth antennas 210, 215, 225 may not re-assessed based on the updated average SNR values.

In the diversity state 310, the diversity engine 140 may further be configured to respond to errors in a substantially similar manner as the poll engine 135. For example, when an error occurs, the diversity engine 140 may switch to the other indicated Bluetooth antenna that was identified by the SNR rank engine 150 as the two Bluetooth antennas to be used by the diversity engine 140. Thus, the switch results in a different active antenna being used. The diversity engine 140 may continue to switch between the two identified Bluetooth antennas (e.g., in a substantially similar manner as a blind switch scheme) until the predetermined threshold of consecutive packets has been received using a selected Bluetooth antenna (as selected by the diversity engine 140). Thus, the mechanism according to the exemplary embodiments may return to the functionality of the poll engine 135. Again, the successful packet count 340 may result in transitioning from the diversity state 310 to the poll state 305.

The diversity engine 140 may use another criteria to determine subsequent operations to be performed using the mechanism according to the exemplary embodiments. For example, this criteria may be when a predetermined error threshold has been reached. For example, an error count 350 may form a basis of the state to be used. As any accumulation of errors may affect the efficacy of the selection between the Bluetooth antennas 210, 215, 225, the predetermined error threshold may prevent the blind switch scheme from being used while in the diversity state 310 for an extended duration. The predetermined error threshold may indicate a maximum number of consecutive errors that are allowed before a different course of action is to be used. The predetermined error threshold may be dynamically selected, e.g., based on current conditions, or may be determined/updated while the UE 105 utilizes the mechanism according to the exemplary embodiments. When the predetermined error threshold is not reached, the diversity engine 140 may continue to switch between the indicated Bluetooth antennas (e.g., remain in the diversity state 310). However, when the predetermined error threshold is reached, the diversity engine 140 may terminate its functionality and the functionality of the subpoll engine 145 may be used. As illustrated, the error count 350 may result in the procedure transitioning from the diversity state 310 to the subpoll state 315.

The subpoll engine 145 may select the Bluetooth antenna to be used in receiving a packet when the predetermined error threshold is met while using the diversity engine 140. When in the subpoll state 315, the subpoll engine 145 may receive information from the SNR rank engine 150 regarding a rank for the Bluetooth engines 210, 215, 225. As noted above, the SNR rank engine 150 may utilize the SNR information to determine a performance based ordering of the Bluetooth engines 210, 215, 225. The SNR rank engine 150 may also indicate the remaining ones of the Bluetooth antennas 210, 215, 225 that are to be used by the subpoll engine 145. With regard to the three Bluetooth antenna arrangement of the antenna arrangement 130 as illustrated FIG. 2, the third Bluetooth antenna (or lowest ranked) may be indicated. In this manner, the subpoll engine 145 may consider this indicated Bluetooth antenna. As described above, the remaining antenna indication 355 may be provided in this manner. In a substantially similar manner as the top antennas indication 335, the remaining antenna indication 355 may be provided, e.g., when the ranking of the Bluetooth antennas 210, 215, 225 occurs or at various intervals.

When in the subpoll state 315, the subpoll engine 145 may subsequently select the active antenna to receive a packet. For example, the subpoll engine 145 may select the remaining indicated Bluetooth antenna. The subpoll engine 145 may select this remaining Bluetooth antenna to be the active antenna to be used in the data exchange. In a substantially similar manner as the diversity engine 140, with regard to the subpoll engine 145, the selected Bluetooth antenna may be used until a predetermined threshold of consecutive packets have been successfully received. The predetermined threshold of consecutive packets used by the subpoll engine 145 may be the same as the predetermined threshold of consecutive packets used by the poll engine 135 and the diversity engine 140, or it may also be set to a different value. Once the selected Bluetooth antenna has been used to successfully receive the predetermined threshold of consecutive packets, the subpoll engine 145 may terminate its functionality and the poll engine 135 may continue or restart the polling procedure (e.g., select the next Bluetooth antenna in the cycle or start a new cycle) as the diversity engine 140 was first used prior to referring to the subpoll engine 145. As illustrated, the predetermined threshold of consecutive packets may result in a successful packet count 365 such that the procedure transitions from the subpoll state 315 back to the poll state 305.

The subpoll engine 145 may further be configured to respond to errors in a substantially similar manner as the poll engine 135 and the diversity engine 140. For example, when an error occurs, the subpoll engine 145 may switch to another remaining indicated Bluetooth antenna (if available). With regard to the antenna arrangement 130 illustrated in FIG. 2, there may be no further remaining indicated Bluetooth antenna. Accordingly, the only remaining Bluetooth antenna may continue to be used by the subpoll engine 145. If more than one remaining Bluetooth antenna is available, the subpoll engine 145 may switch the Bluetooth antenna, such that a different antenna is active. The subpoll engine 145 may continue to switch between the remaining Bluetooth antennas (e.g., in a substantially similar manner as a blind switch scheme or a random selection scheme, e.g., if more than two Bluetooth antennas are available) until the predetermined threshold of consecutive packets has been received using a selected Bluetooth antenna (as selected by the subpoll engine 145). Thus, the mechanism according to the exemplary embodiments may return to the functionality of the poll engine 135 (e.g., via the successful packet count 365).

The subpoll engine 145 may also use other criteria, e.g., as used by the diversity engine 140, with regard to errors. For example, the subpoll engine 145 may utilize a predetermined sub-error threshold that may indicate a maximum number of consecutive errors that are allowed before a different course of action is to be used, e.g., switching antennas. The predetermined sub-error threshold may be dynamically selected based on current conditions or may be determined/updated while the UE 105 utilizes the mechanism according to the exemplary embodiments. In an exemplary embodiment, the predetermined sub-error threshold may be set to a value less than the predetermined error threshold used by the diversity engine 140. However, the predetermined sub-error threshold being less than the predetermined error threshold is only exemplary and these values may be the same or the predetermined sub-error threshold may be greater. When the predetermined sub-error threshold is not reached, the subpoll engine 145 may continue to switch between the remaining Bluetooth antennas (e.g., remain in the subpoll state 315). However, when the predetermined sub-error threshold is reached, the subpoll engine 145 may terminate its functionality and the mechanism according to the exemplary embodiments may instead return to the poll engine 135. In this manner, a soft reset is provided to use the Bluetooth antennas 210, 215, 225 via the polling procedure. As illustrated, a total error count 365 may transition the procedure from the subpoll state 315 to the poll state 305.

The SNR rank engine 150 (e.g., the SNR rank operation 320) may again be used when in the subpoll state 315 in a substantially similar manner as when in the diversity state 310. For example, when the predetermined packet threshold has been reached and for each subsequent packet (if applicable) or for successfully received packets prior to encountering an error, the SNR rank engine 150 may update the average SNR value associated with the selected Bluetooth antenna. As illustrated, a successful packet count 360 may be provided to the SNR rank operation 320. Similar to when the SNR rank engine 150 performs its functionality with regard to the diversity engine 140, the SNR rank engine 150 may only update the average SNR value when the subpoll engine 145 is being used. For example, the rank of the Bluetooth antennas 210, 215, 225 may not re-assessed based on the updated average SNR values.

The selection engine 155 may receive selection information from each of the engines to implement a selection of one of the Bluetooth antennas 210, 215, 225. For example, during the polling procedure of the poll engine 135, a selection among the Bluetooth antennas 210, 215, 225 may be received by the selection engine 155 to generate a corresponding output or instruction for the Bluetooth chip 205. In another example, a selection from the diversity engine 140 or the subpoll engine 145 in performing respective functionalities may be received by the selection engine 155 to generate a corresponding output or instruction for the Bluetooth chip 205. The functionality of the selection engine 155 may be respectively incorporated into the engines 135-150 to instruct the Bluetooth chip 205.

The above description uses predetermined thresholds in which a consecutive number of packets are used as a basis. However, the packets being consecutive is only exemplary. For example, receiving a consecutive number of packets to proceed to a different Bluetooth antenna in the polling procedure performed by the poll engine 135 is only exemplary. In other examples, experiencing errors for a consecutive number of packets to proceed to a different engine is only exemplary. The exemplary embodiments may be utilized or modified so that a cumulative number of packets or errors are tracked for purposes of satisfying the thresholds.

The exemplary embodiments are described with regard to selecting one of the Bluetooth antennas 210, 215, 225 to receive a packet from the Bluetooth device 195. The SNR values, the rank, and the selection for an active Bluetooth antenna to receive a packet may also be used for selecting one of the Bluetooth antennas 210, 215, 225 to transmit a packet to the Bluetooth device 195. For example, a highest ranked one of the Bluetooth antennas 210, 215, 225 may be selected to transmit the packet with an assumption that the ranking determined based on receiving packets transfers to transmitting packets (e.g., reciprocity). When the packet is successfully transmitted, the selected Bluetooth antenna may continue to be used to transmit packets until a different rank is determined, e.g., from receiving packets. When the transmitted packet fails to be successfully received/acknowledged (e.g., a NACK is received or a time out occurs), the UE 105 may switch the Bluetooth antenna and select a different Bluetooth antenna based on the rank. The use of the Bluetooth antennas 210, 215, 225 to transmit packets may also consider a respective transmit power cap for each antenna.

The UE 105 may also include an idle reset functionality. For example, when the UE 105 or the Bluetooth device 195 is mobile, or when the Bluetooth connection is subject to changing conditions, the SNR information and the other tracking metrics may become obsolete (or less relevant) over time. Accordingly, the idle reset functionality may include an idle timer that resets these values to remove information from more than a predetermined time in the past (e.g., stale information). For example, the SNR information, the received packet count, the error count, the active antenna, the next selected antenna, a mode, a miss count, etc. may all be reset upon expiry of this timer. The idle reset functionality may also utilize a moving window so that only information ascertained for a duration of time or predetermined number of slots (e.g., 20 slots, 25 slots, etc.) prior to a current time is to be considered by the engines 135-155. In this manner, information ascertained prior to the moving window may be omitted from consideration as this information may no longer be relevant.

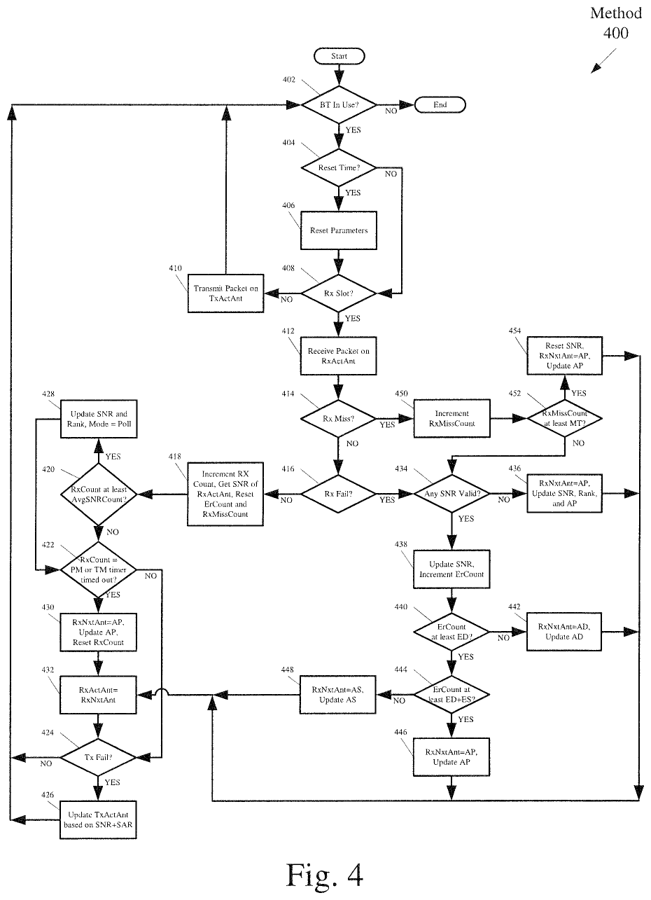

FIG. 4 shows an exemplary method 400 for selecting an antenna according to various exemplary embodiments described herein. The method 400 may relate to how the UE 105 utilizes a polling operation to procedurally select among the Bluetooth antennas 210, 215, 225 and perform further selection operations based on results of the polling operation. The method 400 also illustrates the interaction among the different engines 135-155 as the mechanism according to the exemplary embodiments is performed. The method 400 may be performed by the UE 105 and will be described with regard to the system 100 of FIG. 1 and the UE 105 of FIG. 2.

In 402, the UE 105 determines whether the Bluetooth connection is in use (e.g., via a baseband processor). The mechanism according to the exemplary embodiments may be used at any time that the Bluetooth connection is being established or has been established until a time that the Bluetooth connection is torn down. For example, the UE 105 may determine if handshaking messages are being or have been exchanged between the UE 105 and the Bluetooth device 195 and that a tear down procedure is not being and has not been performed. It is noted that the “use” may refer to any time that the Bluetooth connection is actually in use or intended to be used. In this manner, measurements obtained from use of the Bluetooth antennas 210, 215, 225 during the exchange of handshaking messages may also be used. If the Bluetooth connection is not in use, the method 400 may end.

If the Bluetooth connection is in use, the method 400 continues to 404 where the UE 105 determines whether a reset time has been reached. Information that is obsolete, stale, or otherwise irrelevant (e.g., based on conditions of the UE 105 that are no longer present) may be omitted from consideration. Thus, if the reset timer is reached, in 406, the UE 105 resets parameters so that relevant information is used. If the reset timer is not reached in 404 or after the parameters are reset in 406, the method 400 continues from 404 to 408. The reset may also refer to a moving window of time relative to a current time, so that recent historical information may be used by the engines 135-155.

In 408, the UE 105 determines whether a current slot is scheduled for reception or transmission of a packet. Again, the exemplary embodiments are described with regard to using information ascertained from receiving packets over the Bluetooth connection to select among the Bluetooth antennas 210, 215, 225. Thus, if the current slot indicates that a packet is to be transmitted, the method 400 continues to 410 where the UE 105 transmits the packet on an active one of the Bluetooth antennas 210, 215, 225. As will become evident below, for transmissions, the mechanism according to the exemplary embodiments may select one of the Bluetooth antennas 210, 215, 225 to be the active Bluetooth antenna. The use of the active Bluetooth antenna may be subject to considerations associated with transmissions (e.g., transmit power cap). If a transmission is scheduled in the current slot prior to a selection being determined based on receiving packets, the active Bluetooth antenna may be, e.g., the Bluetooth antenna used in exchanging the handshaking messages. Alternatively, the active Bluetooth antenna may be, for example, a first one of the Bluetooth antennas 210, 215, 225 in the cycle selected to be used in the polling procedure performed by the poll engine 135. After transmitting the packet on the active Bluetooth antenna, the method 400 returns to 402 to proceed to the next slot if the Bluetooth connection is still in use.

If the current slot is scheduled for the UE 105 to receive a packet from the Bluetooth device 195, the UE 105 continues to 412 where the functionalities of the engines 135-155 may be used. In 412, the UE 105 receives the packet on an active Bluetooth antenna. The receiving of the packet at this stage of the method 400 may refer to the polling procedure performed by the poll engine 135. Thus, in receiving the packet, the poll engine 135 may have selected one of the Bluetooth antennas 210, 215, 225 according to a predetermined or dynamically selected cycling order. For illustrative purposes, the method 400 will be described with a predetermined cycling order starting with the Bluetooth antenna 210, proceeding to the Bluetooth antenna 215, and ending with the Bluetooth antenna 225. Thus, the poll engine 135 may have selected (and indicated to the selection engine 155 to instruct the Bluetooth chip 205) the Bluetooth antenna 210. Accordingly, the Bluetooth antenna 210 may be set as the active Bluetooth antenna.

In 414, the UE 105 determines whether an implicit error has occurred in receiving the packet. The poll engine 135 may track a respective outcome of each reception attempt on the selected Bluetooth antenna 210. The implicit error may refer to packet reception being scheduled in the current slot, but being missed. There may be a variety of reasons that the UE 105 may have missed receiving the packet. If the packet was missed, the method 400 continues from 414 to 450, which is described below. However, if the packet was not missed, an implicit error has not occurred, and the packet was at least partially received in the current slot, the method 400 continues from 414 to 416.

In 416, the UE 105 determines whether an explicit error has occurred in receiving the packet. In tracking the outcome of the reception attempt on the selected Bluetooth antenna 210, the explicit error may refer to the packet being scheduled in the current slot and being improperly received (e.g., as determined using a CRC or other verification operation). Like the implicit error, there may be a variety of reasons that the UE 105 may have improperly received the packet (e.g., interference). If the packet was improperly received, the method 400 continues from 416 to 434, which is described below. However, if neither an implicit nor explicit error has occurred, the packet was properly received in the current slot and the method 400 continues from 416 to 418.

In 418, the UE 105 increments a proper receive count, determines the SNR for the active Bluetooth antenna 210, and resets any error count (e.g., referred to as ErCount in FIG. 4) or miss count (e.g., referred to as RxMissCount in FIG. 4). In continuing the polling procedure, the poll engine 135 may increment the receive count to determine whether certain thresholds have been satisfied. For example, the receive count may be used as a basis to determine whether a predetermined threshold of consecutive packets (e.g., referred to as PM in FIG. 4) or a predetermined packet threshold (e.g., referred to as AvgSNRCount in FIG. 4) has been satisfied. In the current iteration of the method 400, since the properly received packet is a first packet, the receive count may be incremented from 0 to 1. In subsequent iterations of the method 400, assuming packets are consecutively received properly, the poll engine 135 may increment the receive count for each instance that this event occurs. For each attempt, the SNR rank engine 150 may also measure the SNR of the active Bluetooth antenna 210. The SNR value may be stored for subsequent calculations. The poll engine 135 may reset the error and miss count (if applicable). For example, the errors and misses may be tracked on a consecutive basis (e.g., a problem occurs when 3 consecutive packets are missed). Thus, if a packet is successfully received with no errors, the error and miss count may be reset to start recording a next set of consecutive errors or misses. Thus, with a successfully received packet, any chain of errors or misses may be broken.

In 420, the UE 105 determines whether the receive count at least equals the predetermined packet threshold. The predetermined packet threshold may be a minimum number of packets that are to be, or that have been, received to average the SNR values of the active Bluetooth antenna 210. For example, the predetermined packet threshold may be set to three packets. Accordingly, if three or more packets are received, the SNR values for each packet reception may be averaged to generate the average SNR value for the active Bluetooth antenna 210. However, since the current iteration is the first packet being received by the active Bluetooth antenna 210, the predetermined packet threshold may not be met. Thus, the method 400 continues from 420 to 422. In subsequent iterations of the method 400, when the predetermined packet threshold has been met and at least three consecutive packets have been received, the method 400 continues from 420 to 428 where the average SNR for the Bluetooth antenna 210 is updated. Again, the SNR rank engine 150 may perform this operation. The SNR rank engine 150 may also update the rank of the Bluetooth antennas 210, 215, 225 if there is a change to the ranking order. The SNR rank engine 150 may also note that the mode is the polling procedure as performed by the poll engine 135. Subsequently, the method 400 continues from 428 to 422.

In 422, the UE 105 determines whether the receive count is at least the predetermined threshold of consecutive packets or whether a time to switch timer (TM) has timed out. The TM timer may be started when the current antenna begins receiving packets. A purpose of the TM timer is to ensure that the data collected for the current antenna is not stale. For example, if the amount of Bluetooth traffic is relatively low, it may take a relatively large amount of time for the current antenna to receive the predetermined threshold of consecutive packets to trigger a switch to the next antenna. This would mean that a relatively large amount of time elapses between the receipt of the first packet and the receipt of the last packet, meaning that the data (e.g., SNR data) that was collected for the first several packets may be stale and may not provide current information for the operations of the method. To prevent this accumulation of stale data, the timer TM operates in a similar manner as the threshold PM. For example, if the timer TM times out before the predetermined number of packets reaches the threshold PM, the method will continue to switch to the next receive antenna in the polling order. Similar to the other thresholds discussed herein, the timer value for the timer TM may be set dynamically, e.g., based on a current level of Bluetooth traffic, or may be a constant value, e.g., based on an acceptable latency of the data (or duration over which the data is gathered).

The predetermined threshold of consecutive packets may be a threshold number of packets that are to be received to switch from the active Bluetooth antenna 210 to the next Bluetooth antenna 215 (as indicated in the cycling order for the polling procedure performed by the poll engine 135). For example, the predetermined threshold of consecutive packets may be the same as the predetermined packet threshold and set to three packets. However, the predetermined threshold of consecutive packets may be equal to or greater than the predetermined packet threshold. However, since the current iteration is the first packet being received by the active Bluetooth antenna 210, the predetermined threshold of consecutive packets may not be met and it may be considered that the timer TM has not timed out. Thus, the method 400 continues from 422 to 424. In subsequent iterations of the method 400, when the predetermined threshold of consecutive packets has been met and at least three consecutive packets have been received or if the timer TM has timed out, the method 400 continues from 422 to 430 which is described below. With the predetermined threshold of consecutive packets being equal to the predetermined packet threshold, when the method 400 continues from 420 to 428 and proceeds to 422, the method 400 also always continues to 430. However, with the predetermined threshold of consecutive packets being greater than the predetermined packet threshold, when the method 400 continues from 420 to 428 and proceeds to 422, the method 400 may proceed to 424 or 430. In addition, each additional packet that is successfully received may be used in 428 to update the average SNR value and rank for the active Bluetooth antenna 210 until the predetermined threshold of consecutive packets is satisfied in 422.

In 424, the UE 105 determines if there has been a transmission failure that occurred between packet receptions. The mechanism according to the exemplary embodiments may also be used in transmitting packets such that the active Bluetooth antenna may be switched when an error occurs (e.g., an implicit error when a time out occurs or an explicit error when a NACK is returned). Thus, if no transmission failure occurs, the method 400 returns to 402. If a transmission failure occurs, the method 400 continues to 426 where the UE 105 updates the active Bluetooth antenna to transmit packets based on the SNR information provided by the SNR rank engine 150 (e.g., average SNR values, specific absorption rate (SAR) measurements, etc.). It is noted that 424 and 426 may also be looped into the method 400 after 410 to verify if the packet transmission performed in 410 was successful.

Returning to 422, if the receive count at a subsequent packet reception results in the predetermined threshold of consecutive packets being satisfied or if the timer TM has timed out, the method 400 continues from 422 to 430 where the UE 105 switches the Bluetooth antenna to be used in the polling procedure performed by the poll engine 135 by selecting the next Bluetooth antenna 215, e.g., as indicated in the cycling order (e.g., referred to as RxNxtAnt in FIG. 4) to be the antenna of the polling procedure (e.g., referred to as AP in FIG. 4). The poll engine 135 may update the antenna of the polling procedure and reset a receive count as a new active Bluetooth antenna will be polled. In 432, the UE 105 switches the active Bluetooth antenna (e.g., referred to as RxActAnt in FIG. 4) from the Bluetooth antenna 210 to the Bluetooth antenna 215. For example, the poll engine 135 may generate an output for the selection engine 155 to instruct the Bluetooth chip 205. The UE 105 then continues to 424 to determine any changes to the active Bluetooth antenna used in transmitting packets.

Returning to 416, when the packet is not missed, but the packet is improperly received, the method 400 continues from 416 to 434. When an error is experienced during the polling procedure performed by the poll engine 135, the polling procedure may terminate at least temporarily to determine whether a different operation is to be used. For example, the criteria to determine whether the different operation is to be used may be performed in 434. In 434, the UE 105 determines whether any of the Bluetooth antennas 210, 215, 225 has an average SNR value that satisfies a predetermined minimum SNR value. In performing its functionality, the SNR rank engine 150 may indicate whether any one or more of the Bluetooth antennas 210, 215, 225 satisfy the predetermined minimum SNR value. If information is unavailable or the predetermined minimum SNR value is not met, the method 400 continues from 434 to 436, where the UE 105 switches the Bluetooth antenna to be used in the polling procedure performed by the poll engine 135 by selecting the next Bluetooth antenna 215 as indicated in the cycling order. The polling procedure performed by the poll engine 135 may continue. The SNR rank engine 150 may update the average SNR value and rank based on any SNR values measured for the active Bluetooth antenna 210 prior to the switch. The method 400 then continues from 436 to 432 and is performed as described above.

Returning to 434, if there is at least one of the Bluetooth antennas 210, 215, 225 that satisfies the predetermined SNR value, the method 400 continues from 434 to 438 where the UE 105 updates the average SNR value (e.g., performed by the SNR rank engine 150) and increments the error count. The error count may be used as a basis to determine a subsequent operation. For example, the error count may be used initially with regard to a predetermined error threshold (e.g., referred to as ED in FIG. 4). Thus, in 440, the UE 105 determines whether the error count is at least the predetermined error threshold. As described above, the error threshold ED may be considered the number of consecutive errors up to which the diversity mechanism may be used. If the error count is less than the error threshold ED, the diversity mechanism may be used as described. If the error count is greater than or equal to the error threshold ED, the subpolling mechanism or the polling mechanism may then be used, e.g., as described in greater detail below. Since the error count is based on consecutive errors, if any packets are received successfully, the error count value is reset as shown in 418. However, the method 400 may be modified to operate based on cumulative errors rather than consecutive errors.

If the error count is less than the predetermined error threshold, the method 400 continues from 440 to 442. The functionality of the diversity engine 140 may be called upon in view of experiencing the error and the number of errors being within an acceptable limit. In 442, the UE 105 switches the Bluetooth antenna by selecting the next Bluetooth antenna as indicated by the SNR rank engine 150 to be the antenna used by the diversity engine 140 (e.g., referred to as AD in FIG. 4). The SNR rank engine 150 may determine the top two ranked antennas of the Bluetooth antennas 210, 215, 225 based on the average SNR values. The SNR rank engine 150 may provide this indication of the two Bluetooth antennas to the diversity engine 140. For illustrative purposes, it may be assumed that the Bluetooth antennas 210 and 215 are determined to be the top two ranked Bluetooth antennas. Thus, the diversity engine 140 may select the Bluetooth antenna 215. The diversity engine 140 may include a redundancy feature to prevent the active Bluetooth antenna from being selected if indicated as being one of the top two performing Bluetooth antennas. Accordingly, with Bluetooth antenna 210 being active and being in the top two ranked Bluetooth antennas, the diversity engine 140 may select the Bluetooth antenna 215. If the active Bluetooth antenna is the Bluetooth antenna 225, the diversity engine 140 may select the top ranked Bluetooth antenna from the indicated Bluetooth antennas 210, 215 or randomly select one. The method 400 continues from 442 to 432 where the diversity engine 140 may generate an output for the selection engine 155 to instruct the Bluetooth chip 205 in switching to the Bluetooth antenna 215. The method 400 may also be modified to loop back to, for example, 408 so that error counts may be updated for the predetermined error threshold and switches performed by the diversity engine 140 may be performed.

Returning to 440, when the error count is at least the predetermined error threshold ED, the method 400 continues from 440 to 444 where the UE 105 determines whether the error count is at least an error sum of the predetermined error threshold ED and a predetermined sub-error threshold (e.g., referred to as ES in FIG. 4). Thus, in this example, since the error count is not reset after reaching the predetermined error threshold ED and the sub-error threshold ES has its own value, the threshold for leaving the sub polling mechanism is ED+ES. When the error count is at least the predetermined error threshold (ED), the diversity engine 140 may pass operations to the subpoll engine 145. Thus, the subpoll engine 145 may perform its functionality by initially determining whether the error count is at least the error sum (ED+ES), as described above. When the error count is at least the error sum, the method 400 continues from 444 to 446 where the UE 105 switches the Bluetooth antenna to be used in the polling procedure performed by the poll engine 135 by selecting the next Bluetooth antenna 215, as indicated in the cycling order to be the antenna of the polling procedure. The method 400 then continues from 446 to 432 and is performed as described above.

Returning to 444, when the error count is less than the error sum (ED+ES), the UE 105 switches the Bluetooth antenna by selecting the next Bluetooth antenna, as indicated by the SNR rank engine 150 to be the antenna used by the subpoll engine 140 (e.g., referred to as AS in FIG. 4). The SNR rank engine 150 may determine the top two ranked antennas and the remaining antenna of the Bluetooth antennas 210, 215, 225 based on the average SNR values. Using the above example, in which the Bluetooth antennas 210 and 215 are determined to be the top two ranked Bluetooth antennas, the remaining Bluetooth antenna may be the Bluetooth antenna 225. Thus, the subpoll engine 145 may select the Bluetooth antenna 225. The method 400 continues from 448 to 432 where the subpoll engine 145 may generate an output for the selection engine 155 to instruct the Bluetooth chip 205 in switching to the Bluetooth antenna 225.

The method 400 may be modified for different antenna arrangements that, e.g., may include more than three Bluetooth antennas. For example, with four Bluetooth antennas, two of these Bluetooth antennas may be determined to be the top two ranked Bluetooth antennas. Thus, there may be two remaining Bluetooth antennas that are indicated by the SNR rank engine 150 to the subpoll engine 145. When a plurality of remaining Bluetooth antennas is provided to the subpoll engine 145, the subpoll engine 145 may select a higher ranked Bluetooth antenna or a random Bluetooth antenna to be used. The method 400 may also be modified to loop back to, for example, 408 so that error counts may be updated for the predetermined sub-error threshold and switches performed by the subpoll engine 145 may be performed.

Returning to 414, when an implicit error is experienced, the method 400 may continue from 414 to 450 where the UE 105 may increment a miss count. The miss count may track a consecutive number of packets that are missed by the active Bluetooth antenna 210. The miss count may be used as a basis to determine a subsequent operation. For example, the miss count may be used with regard to a predetermined miss threshold (e.g., referred to as MT in FIG. 4). Thus, in 452, the UE 105 determines whether the miss count is at least the predetermined miss threshold.

If the miss count is less than the predetermined miss threshold (MT), the method 400 continues from 452 to 434 and the mechanism according to the exemplary embodiments may proceed as described above in using the diversity engine 140, the subpoll engine 145, or continuing with the polling procedure performed by the poll engine 135. However, when the miss count is at least the predetermined miss threshold (MT), the method 400 continues from 452 to 454 where the UE 105 switches the Bluetooth antenna to be used in the polling procedure performed by the poll engine 135 by selecting the next Bluetooth antenna as indicated in the cycling order to be the antenna of the polling procedure. The polling procedure performed by the poll engine 135 may continue. The SNR rank engine 150 may reset the SNR in view of the miss count satisfying the predetermined miss threshold. The method 400 continues from 454 to 432 and is performed as described above.

The exemplary embodiments provide a device, system, and method of selecting among three or more Bluetooth antennas. By introducing more than two Bluetooth antennas, conventional selection mechanisms such as the blind switch scheme may not provide the same benefits when only two Bluetooth antennas are selectable. The mechanisms according to the exemplary embodiments utilize a polling procedure in which the Bluetooth antennas may be cycled to perform data exchanges. Based on current conditions and event based triggers, the mechanism according to the exemplary embodiments may revert to the blind switch scheme where two of the Bluetooth antennas are identified to be used in addition to a fallback scheme where remaining Bluetooth antennas may be used.

In using the top ranked two diversity mechanism according to the exemplary embodiments, experimentation has shown better performance over other available selection mechanisms that may be used with three or more Bluetooth antennas. For example, a first conventional approach may be a rank based switch mechanism where all Bluetooth antennas are ranked and the UE systematically switches to the next best Bluetooth antenna after each error. In another example, a second conventional approach may be a full blind switch mechanism where the UE blindly switches to another Bluetooth antenna after each error. In a first experimentation when all the Bluetooth antennas are substantially balanced where all the Bluetooth antennas have a similar performance and where the best two diversity mechanism according to the exemplary embodiments serves as a baseline, the rank based switch mechanism performs substantially similar to the baseline with slightly lower performance. However, the full blind switch mechanism performs noticeably worse, performing approximately 1 dB worse. In a second experimentation when the Bluetooth antennas are imbalanced where one or more Bluetooth antennas may perform poorly (e.g., due to grip, design, etc.) and where the best two diversity mechanism according to the exemplary embodiments serves as a baseline, both the rank based switch mechanism and the full blind switch mechanism perform noticeably worse. For example, the rank based switch mechanism performs approximately 1.5 dB worse while the full blind switch mechanism performs approximately 3 dB worse.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
at a user equipment including an antenna arrangement comprising at least three antennas configured for use with a wireless connection:
for each antenna of the at least three antennas, determining a performance metric associated with a data exchange over the wireless connection;
ranking each antenna of the at least three antennas based at least in part on the performance metric; and
selecting, when a data exchange error is detected, one of a first ranked antenna or a second ranked antenna of the at least three antennas for a next data exchange.

2. The method of claim 1, wherein the determining the performance metric comprises:
selecting one of the antennas as an active antenna based at least on a polling cycling order;
performing a data exchange using the active antenna;
tracking an outcome of the data exchange;
when the outcome indicates that the data exchange is successful, incrementing an exchange count for the active antenna; and
when the exchange count satisfies an exchange threshold, selecting a next one of the at least three antennas as the active antenna.

3. The method of claim 2, further comprising:
determining, when a further data exchange error is detected from using one of the first or second ranked antenna, an error count associated with using the first and second ranked antenna; and
selecting, when the error count is below a predetermined threshold, the other one of the first or second ranked antenna for a subsequent data exchange.

4. The method of claim 3, further comprising:
when the error count satisfies the predetermined threshold, selecting one of the antennas that is not the first or second ranked antenna for the subsequent data exchange.

5. The method of claim 4, further comprising:
when a subsequent data exchange error is detected, determining a further error count associated with using the one of the antennas that is not the first or second ranked antenna; and
when the further error count is at least a further predetermined threshold, selecting the active antenna based at least on the polling cycling order.

6. The method of claim 1, further comprising:
determining a further performance metric for each further data exchange over the wireless connection performed via one of the first ranked antenna or the second ranked antenna.

7. The method of claim 6, wherein the further performance metric is omitted from the ranking the antennas.

8. The method of claim 1, further comprising:
when the data exchange error is detected, prior to the selecting, determining whether the performance metric for at least one of the antennas is above a performance threshold,
wherein, when the performance metric for at least one of the antennas is above the performance threshold, one of the first ranked antenna or the second ranked antenna is selected for the next data exchange is performed, and
wherein, when the performance metric for each of the antennas is below the performance threshold, an inactive antenna is selected for the next data exchange.

9. The method of claim 1, wherein the performance metric comprises a signal to noise ratio (SNR) value.

10. The method of claim 1, wherein the wireless connection comprises a Bluetooth connection.

11. A user equipment, comprising:
a transceiver configured to establish a wireless connection;
an antenna arrangement comprising at least three antennas configured for use with the wireless connection; and
a processor configured to, for each antenna of the at least three antennas, determine a performance metric associated with a data exchange over the wireless connection, rank each antenna of the at least three antennas based at least in part on the performance metric and select, when a data exchange error is detected, one of a first ranked antenna or a second ranked antenna of the at least three antennas for a next data exchange.

12. The user equipment of claim 11, wherein the processor is further configured to determine the performance metric by:
selecting one of the antennas as an active antenna based at least on a polling cycling order;
performing a data exchange using the active antenna;
tracking an outcome of the data exchange;
when the outcome indicates that the data exchange is successful, incrementing an exchange count for the active antenna; and
when the exchange count satisfies an exchange threshold, selecting a next one of the at least three antennas as the active antenna.

13. The user equipment of claim 12, wherein the processor is further configured to determine, when a further data exchange error is detected from using one of the first or second ranked antenna, an error count associated with using the first and second ranked antennas, wherein, when the error count is below a predetermined threshold, the processor selects the other one of the first or second ranked antenna for an ensuing data exchange.

14. The user equipment of claim 13, wherein, when the error count satisfies the predetermined threshold, the processor selects one of the antennas that is not the first or second ranked antenna for the subsequent data exchange.

15. The user equipment of claim 14, wherein, when a subsequent data exchange error is detected, the processor determines a further error count associated with using the remaining one of the antennas, wherein, when the further error is at least a further predetermined threshold, the processor selects the active antenna based at least on the polling cycling.

16. The user equipment of claim 11, wherein the processor determines a further performance metric for each further data exchange over the wireless connection performed via one of the first ranked antenna or the second ranked antenna.

17. The user equipment of claim 11, wherein the processor is further configured to, when the data exchange error is detected and prior to the selecting, determine whether the performance metric for at least one of the antennas is above a performance threshold,
wherein, when the performance metric for at least one of the antennas is above the performance threshold, one of the first ranked antenna or the second ranked antenna is selected for the next data exchange is performed, and
wherein, when the performance metric for each of the antennas is below the performance threshold, an inactive antenna is selected for the next data exchange.

18. The user equipment of claim 11, wherein the performance metric comprises a signal to noise ratio (SNR) value.

19. The user equipment of claim 11, wherein the wireless connection comprises a Bluetooth connection.

20. An integrated circuit for use in a device that is configured to establish a wireless connection using an antenna arrangement comprising at least three antennas configured for use with the wireless connection, comprising:
for each antenna of the at least three antennas, circuitry to determine a performance metric associated with a data exchange over the wireless connection;
circuitry to rank each antenna of the at least three antennas based at least in part on the performance metric; and
circuitry to select, when a data exchange error is detected, one of a first ranked antenna or a second ranked antenna of the at least three antennas for a next data exchange.
